(19) United States
(12) Patent Application Publication
(10) Pub. No.: US 2026/0098749 A1
(43) Pub. Date: Apr. 9, 2026

(54) VEHICLE SENSOR ASSEMBLY

(71) Applicant: Ford Global Technologies, LLC, Dearborn, MI (US)

(72) Inventors: Michael Robertson, JR., West Bloomfield, MI (US); Aaron Bradley Johnson, Allen Park, MI (US); Segundo Baldovino, Novi, MI (US); Venkatesh Krishnan, Canton, MI (US)

(73) Assignee: Ford Global Technologies, LLC, Dearborn, MI (US)

(21) Appl. No.: 18/898,928

(22) Filed: Sep. 27, 2024

(51) Int. Cl. G01D 11/24; B60R 11/00; G01D 11/26; H05B 3/14

(52) U.S. Cl. CPC G01D 11/245; B60R 11/00; G01D 11/26; H05B 3/146; B60R 2011/0082; B60R 2011/0084; B60R 2011/0092

(57) ABSTRACT

A sensor assembly includes a chamber extending downward from a roof panel of a vehicle and a sensor unit mounted to the chamber. The sensor unit is vertically movable between a retracted position in the chamber and an extended position extending above the roof panel. The sensor unit includes a base, an environmental sensor fixedly mounted to the base, a cover positioned above the environmental sensor and fixed relative to the base, a first seal extending around the cover, and a second seal extending around the base. The first seal is watertight with the roof panel when the sensor unit is in the retracted position. The second seal is watertight with the roof panel when the sensor unit is in the extended position.

### BACKGROUND

Vehicles typically include a variety of sensors. Some sensors detect the position or orientation of the vehicle, for example, global positioning system (GPS) sensors; accelerometers, such as piezo-electric or microelectromechanical systems (MEMS); gyroscopes such as rate, ring laser, or fiber-optic gyroscopes; inertial measurement units (IMU); and magnetometers. Some sensors detect objects external to a vehicle, for example, radar sensors, scanning laser range finders, light detection and ranging (lidar) devices, and image processing sensors such as cameras.

### BRIEF DESCRIPTION OF THE DRAWINGS

FIG. 1A is a perspective view of a portion of an example vehicle with a sensor assembly including a sensor unit in a retracted position.

FIG. 1B is a perspective view of the portion of the vehicle with the sensor unit in an extended position.

FIG. 2A is a side cross-sectional view of the sensor assembly with the sensor unit in the retracted position.

FIG. 2B is a side cross-sectional view of the sensor assembly with the sensor unit in the extended position.

FIG. 2C is a side cross-sectional view of the sensor assembly with the sensor unit in the extended position and tilted downward.

FIG. 3 is a perspective view of the sensor assembly with the sensor unit in the retracted position showing a heater of the sensor assembly.

FIG. 4 is a side cross-sectional view of the sensor assembly including a drainage system.

FIG. 5 is a block diagram of an example control system for the sensor assembly.

### DETAILED DESCRIPTION

Disclosed herein is a sensor assembly installed in a vehicle. The sensor assembly is retractable, with a sensor unit vertically movable between a retracted position in a chamber below a roof panel of the vehicle and an extended position above the roof panel. For example, the sensor unit may be operating in the extended position at lower speeds of the vehicle, and the sensor unit may be in the retracted position at higher speeds. The sensor assembly includes a first seal around a cover that is positioned above an environmental sensor of the sensor unit. The cover may be flush with the roof panel when the sensor unit is in the retracted position, and the first seal provides a watertight seal with the roof. The sensor assembly further includes a second seal around a base of the sensor unit. The second seal is watertight with the roof panel when the sensor unit is in the extended position, meaning that the sensor assembly can keep out liquids and debris from the chamber in both positions of the sensor unit.

A sensor assembly includes a chamber extending downward from a roof panel of a vehicle and a sensor unit mounted to the chamber. The sensor unit is vertically movable between a retracted position in the chamber and an extended position extending above the roof panel. The sensor unit includes a base, an environmental sensor fixedly mounted to the base, a cover positioned above the environmental sensor and fixed relative to the base, a first seal extending around the cover, and a second seal extending around the base. The first seal is watertight with the roof panel when the sensor unit is in the retracted position. The second seal is watertight with the roof panel when the sensor unit is in the extended position.

In an example, the roof panel may include a cutout through which the sensor unit in the extended position extends, the first seal may extend along a full perimeter of the cutout when the sensor unit is in the retracted position, and the second seal may extend along the full perimeter of the cutout when the sensor unit is in the extended position.

In an example, the cover may be flush with the roof panel when the sensor unit is in the retracted position.

In an example, the sensor unit may include a sensor lens, a field of view of the environmental sensor projecting through the sensor lens in a vehicle-forward direction, and a portion of the first seal may be positioned above the sensor lens and in the vehicle-forward direction from the sensor lens.

In an example, the sensor assembly may further include a motor arranged to move the sensor unit from the retracted position to the extended position and from the extended position to the retracted position. In a further example, the motor may be a first motor, and the sensor assembly may further include a second motor arranged to move the sensor unit from the retracted position to the extended position and from the extended position to the retracted position, the second motor positioned in a vehicle-forward direction from the first motor. In a yet further example, the first motor and the second motor may be arranged to, while the sensor unit remains in the extended position, adjust a pitch of the sensor unit. In a still yet further example, the sensor assembly may further include a computer communicatively coupled to the first motor and the second motor, and the computer may be programmed to actuate at least one of the first motor or the second motor to adjust the pitch of the sensor unit based on data indicating a pitch of the vehicle.

In an example, the sensor assembly may further include a wiper blade fixed relative to the chamber, the sensor unit may include a sensor lens, a field of view of the environmental sensor projecting through the sensor lens, and the wiper blade may be positioned to wipe the sensor lens as the sensor unit moves between the retracted position and the extended position.

In an example, the sensor unit may further include a heater positioned to heat the cover. In a further example, the cover may be formed of conductive plastic, the conductive plastic being the heater.

In another further example, the sensor unit may include a plurality of heaters including the heater, the heaters positioned to heat respective zones of the cover.

In an example, the sensor assembly may further include a nozzle, the sensor unit may include a sensor lens, a field of view of the environmental sensor projecting through the sensor lens, and the nozzle may be aimed at the sensor lens when the sensor unit is in the retracted position. In a further example, the nozzle may be movable with the sensor unit between the retracted position and the extended position.

In another further example, the nozzle may be fixed relative to the chamber.

In an example, the sensor assembly may further include a drain tube positioned to receive fluid from the chamber and extending downward from the chamber. In a further example, the drain tube may be positioned to direct the fluid to a reservoir of the vehicle. In a yet further example, the sensor assembly may further include a filter positioned to filter the fluid passing through the drain tube before the fluid reaches the reservoir.

A sensor assembly includes a chamber extending downward from a roof panel of a vehicle, a sensor unit mounted to the chamber, a first motor, and a second motor positioned in a vehicle-forward direction from the first motor. The sensor unit is vertically movable between a retracted position in the chamber and an extended position extending above the roof panel. The first motor and the second motor are arranged to move the sensor unit from the retracted position to the extended position and from the extended position to the retracted position. The first motor and the second motor are arranged to, while the sensor unit remains in the extended position, adjust a pitch of the sensor unit.

With reference to the Figures, wherein like numerals indicate like parts throughout the several views, a sensor assembly 105 includes a chamber 205 extending downward from a roof panel 115 of a vehicle 100 and a sensor unit 110 mounted to the chamber 205. The sensor unit 110 is vertically movable between a retracted position in the chamber 205 and an extended position extending above the roof panel 115. The sensor unit 110 includes a base 210, an environmental sensor 120 fixedly mounted to the base 210, a cover 125 positioned above the environmental sensor 120 and fixed relative to the base 210, a first seal 130 extending around the cover 125, and a second seal 135 extending around the base 210. The first seal 130 is watertight with the roof panel 115 when the sensor unit 110 is in the retracted position. The second seal 135 is watertight with the roof panel 115 when the sensor unit 110 is in the extended position.

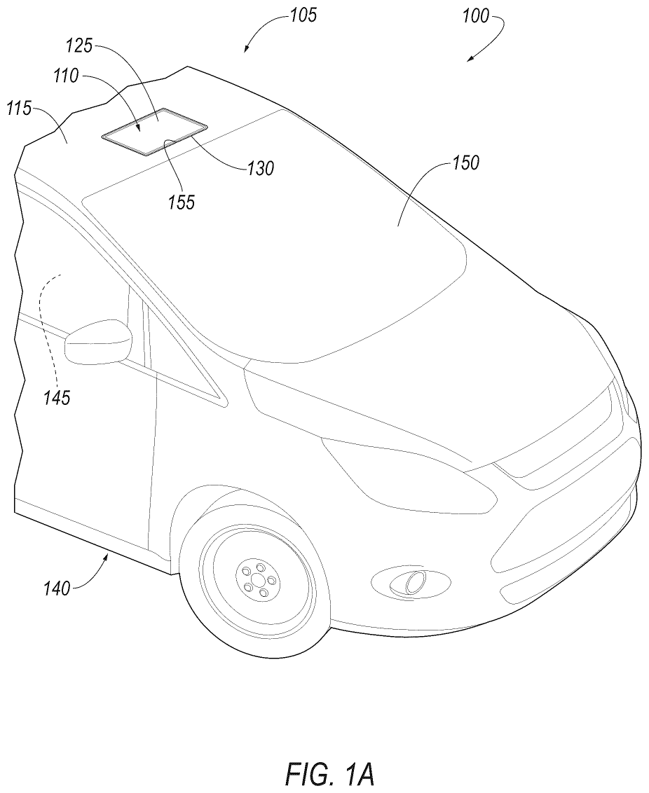

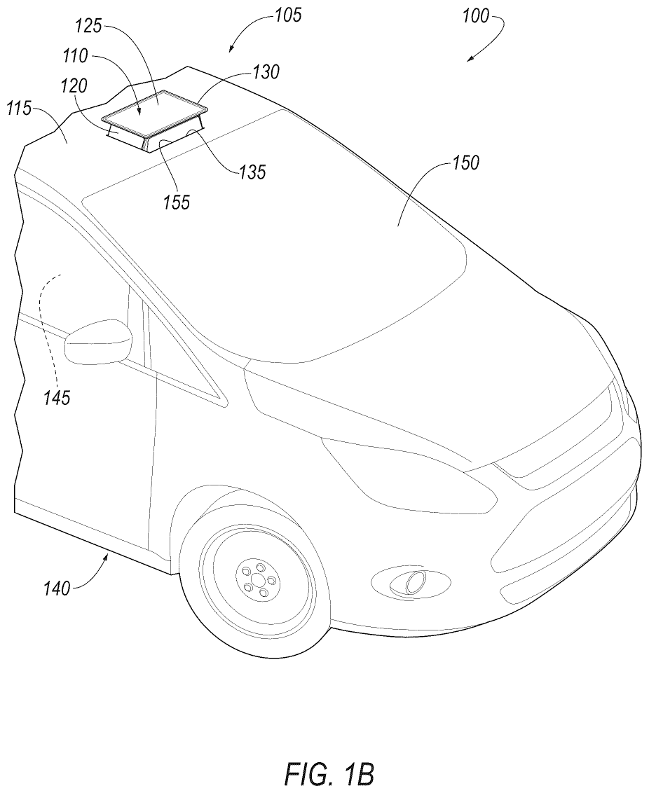

With reference to FIGS. 1A-B, the vehicle 100 includes the sensor assembly 105. The vehicle 100 may be any passenger or commercial automobile such as a car, a truck, a sport utility vehicle, a crossover, a van, a minivan, a taxi, a bus, etc.

The vehicle 100 includes a body 140. The vehicle 100 may be of a unibody construction, in which a frame and the body 140 of the vehicle 100 are a single component. The vehicle 100 may, alternatively, be of a body-on-frame construction, in which the frame supports the body 140 that is a separate component from the frame. The frame and body 140 may be formed of any suitable material, for example, steel, aluminum, etc.

The vehicle 100 (e.g., the body 140 and/or the sensor assembly 105) includes the roof panel 115. The roof panel 115 extends above a passenger compartment 145 of the vehicle 100 and serves as a topmost structure of the passenger compartment 145. The roof panel 115 extends between two or more roof beams of the vehicle 100 and is supported by the roof beams. The roof panel 115 extends rearward from a windshield 150 of the vehicle 100. The roof panel 115 may be a separate panel from the windshield 150 or may be a continuation of the windshield 150.

The roof panel 115 includes a cutout 155. The cutout 155 defines an opening through the roof panel 115. The cutout 155 extends through the roof panel 115 from a bottom surface of the roof panel 115 to a top surface of the roof panel 115. The cutout 155 includes an interior surface extending from the bottom surface of the roof panel 115 to the top surface of the roof panel 115. The cutout 155 may be spaced from the side and rear edges of the roof panel 115 and may border a front edge of the roof panel 115 (i.e., at the windshield 150). The interior surface may extend completely around the cutout 155. The interior surface circumscribes the opening defined by the cutout 155.

The sensor unit 110 is positioned at the cutout 155 of the roof panel 115. The sensor unit 110 may be laterally centered at the front edge of the roof panel 115. This position can provide the environmental sensor 120 with an unobstructed field of view of an area around the front of the vehicle 100 when the sensor unit 110 is in the extended position (as shown in FIG. 1B).

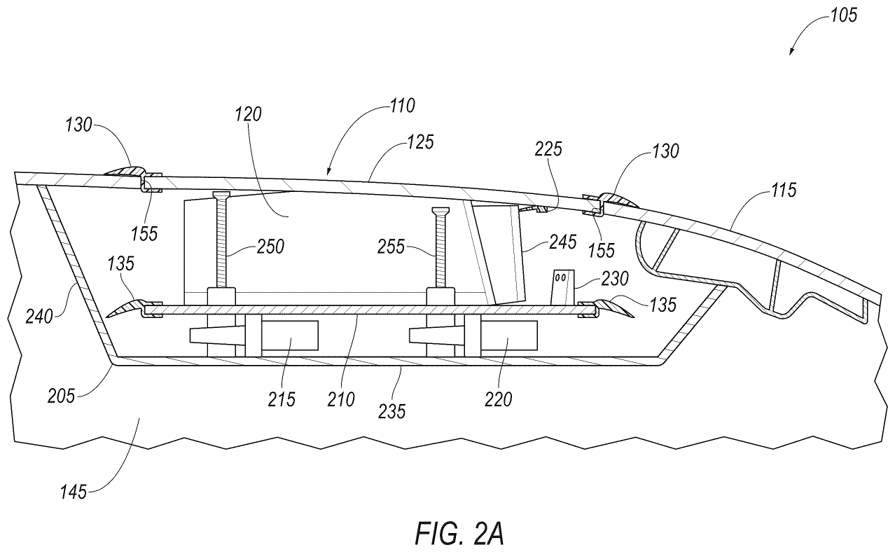

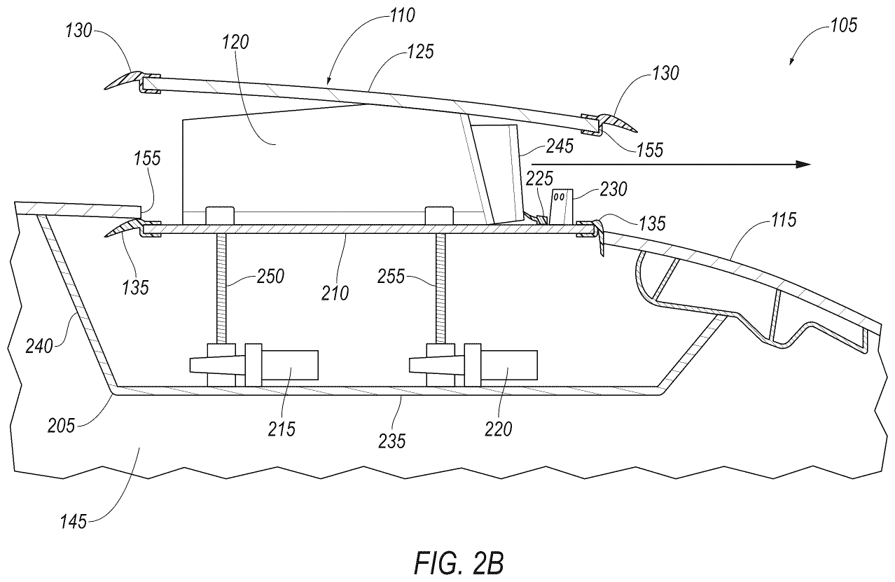

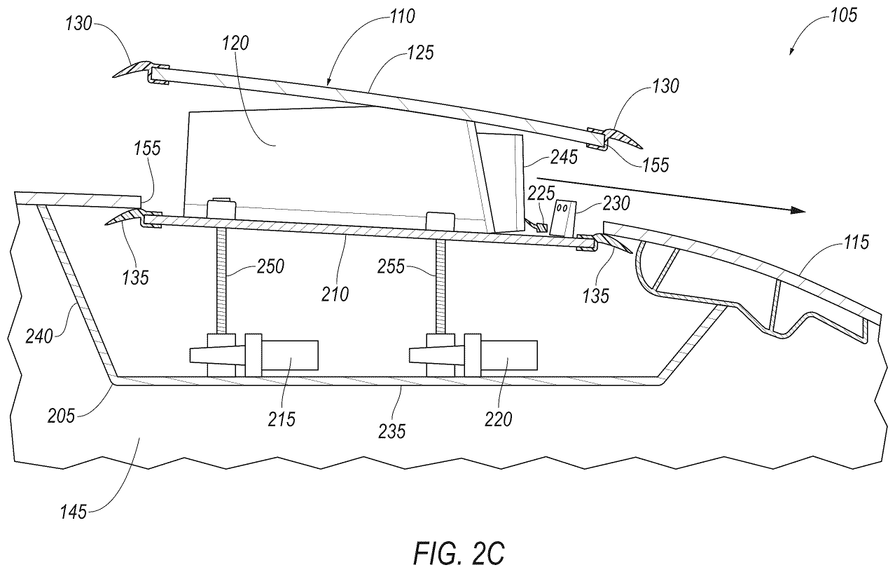

The sensor unit 110 is vertically movable between the retracted position below the roof panel 115 (as shown in FIG. 1A) and the extended position extending above the roof panel 115 (as shown in FIG. 1B). The sensor unit 110 in the retracted position is within the chamber 205 (as shown in FIG. 2A). When the sensor unit 110 is in the retracted position, the cover 125 may be flush with the roof panel 115. For the purposes of this disclosure, “flush” is defined as two surfaces being joined closely enough to not cause turbulence in air flow from one surface to the other surface. In this case, a seam between the cover 125 and the roof panel 115 and/or the windshield 150 does not cause turbulence in air flow along the windshield 150 and roof panel 115. The sensor unit 110 in the retracted position thus provides low drag for the vehicle 100. The sensor unit 110 in the extended position extends through the cutout 155 such that the environmental sensor 120 has a field of view beginning above the roof panel 115. The sensor unit 110 in the extended position may have a height providing an unobstructed view of objects around the front of the vehicle 100.

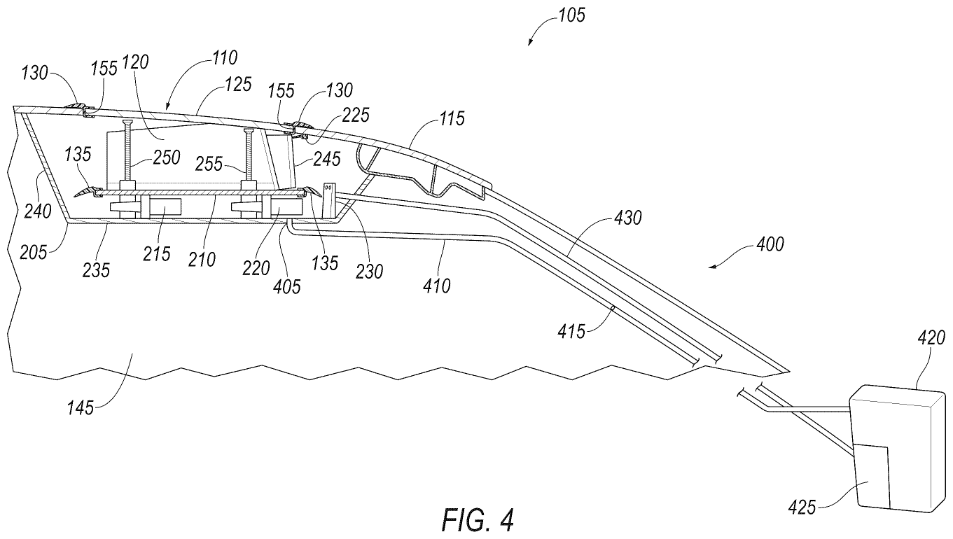

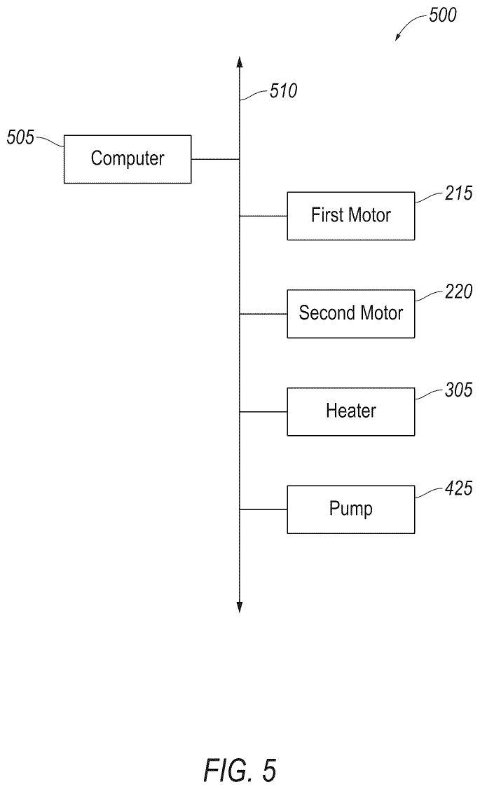

With reference to FIG. 2A-C, the sensor assembly 105 may include the roof panel 115, the chamber 205, the sensor unit 110, a first motor 215, a second motor 220, a wiper blade 225, a nozzle 230, a drainage system 400 (shown in FIG. 4), and a control system 500 (shown in FIG. 5).

The chamber 205 extends downward from the roof panel 115 and may protrude into the passenger compartment 145. The chamber 205 may enclose and define an interior volume, and the sensor unit 110 may be positioned in the interior volume when the sensor unit 110 is in the retracted position. The chamber 205 separates the interior volume from the passenger compartment 145. The chamber 205 may include a bottom panel 235 and side panels 240 extending from the roof panel 115 to the bottom panel 235. The side panels 240 may extend upward and outward from the bottom panel 235 to the roof panel 115.

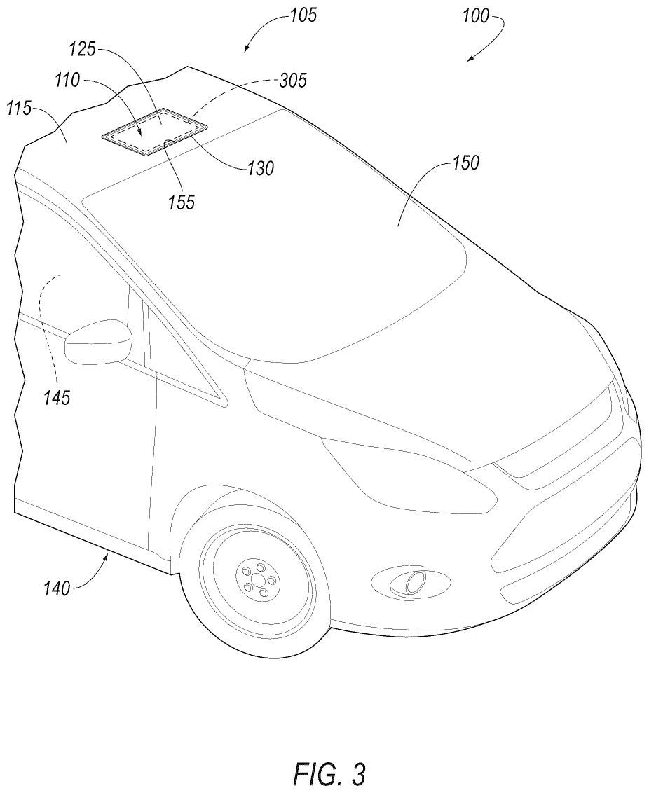

The sensor unit 110 includes the base 210, the environmental sensor 120, a sensor lens 245, the cover 125, the first seal 130, the second seal 135, and a heater 305 (shown in FIG. 3). The components of the sensor unit 110 may be attached together and fixed relative to one another. The components of the sensor unit 110 move up and down between the retracted position and the extended position together.

The sensor unit 110 is mounted to the chamber 205. For example, the sensor unit 110 may be attached to the chamber 205 via the first motor 215 and the second motor 220, as described below.

The base 210 is a platform on which other components, such as the environmental sensor 120 and the nozzle 230, may be mounted. The base 210 may have a generally planar shape, in other words, lengths in two dimensions that are significantly greater than a length in the third dimension, in this case, a length along a longitudinal axis of the vehicle 100 and a width along a lateral axis of the vehicle 100 that are each significantly greater than a thickness along a vertical axis of the vehicle 100. The shape of the base 210 viewed from above (i.e., a projection of the shape onto a horizontal plane) corresponds to a shape of the cutout 155 (e.g., rectangular). When the sensor unit 110 is in the extended position (as shown in FIGS. 2B-C), the base 210 may be positioned inside the cutout 155. For example, the base 210 may be flush with the roof panel 115 when the sensor unit 110 is in the extended position. The base 210 may have a slightly shorter length and slightly shorter width than the cutout 155 so as to leave space for the second seal 135.

The environmental sensor 120 may be fixedly mounted to the base 210 (e.g., fastened to the base 210). The environmental sensor 120 is a sensor that detects the external world, including objects and/or characteristics of surroundings of the vehicle 100, such as other vehicles, road lane markings, traffic lights and/or signs, road users, etc. For example, the environmental sensor 120 is may be a radar, an ultrasonic sensor, a scanning laser range finder, a light detection and ranging (lidar) device, or an image processing sensor such as a camera.

The sensor lens 245 protects the environmental sensor 120 while permitting the environmental sensor 120 to detect the environment. The field of view of the environmental sensor 120 projects through the sensor lens 245. For example, the sensor lens 245 may be positioned in a vehicle-forward direction from the environmental sensor 120, and the environmental sensor 120 may be oriented such that the field of view projects through the sensor lens 245 in the vehicle-forward direction. The sensor lens 245 may be mounted onto a housing of the environmental sensor 120. The sensor lens 245 is transparent with respect to whatever medium the environmental sensor 120 is capable of detecting. For example, if the environmental sensor 120 is a lidar, then the sensor lens 245 is transparent with respect to visible light at the wavelength generated and detectable by the environmental sensor 120.

The cover 125 is positioned above the environmental sensor 120 and fixed relative to the base 210. For example, the cover 125 may be fixedly mounted on top of the environmental sensor 120. The cover 125 may have a generally planar shape, in other words, lengths in two dimensions that are significantly greater than a length in the third dimension, in this case, a length along a longitudinal axis of the vehicle 100 and a width along a lateral axis of the vehicle 100 that are each significantly greater than a thickness along a vertical axis of the vehicle 100. The shape of the cover 125 viewed from above (i.e., a projection of the shape onto a horizontal plane) corresponds to a shape of the cutout 155 (e.g., rectangular). When the sensor unit 110 is in the retracted position (as shown in FIG. 2A), the cover 125 may be positioned inside the cutout 155. For example, the cover 125 may be flush with the roof panel 115 when the sensor unit 110 is in the retracted position. The cover 125 may have a slightly shorter length and slightly shorter width than the cutout 155 so as to leave space for the first seal 130. The cover 125 may have an outer perimeter with the same shape and dimensions as an outer perimeter of the base 210.

The sensor assembly 105 includes the first motor 215 and the second motor 220. The first motor 215 and the second motor 220 may be, for example, electric motors that output rotational motion, as is known. The first motor 215 and the second motor 220 may be fixedly mounted to the chamber 205 (e.g., fastened to the bottom panel 235). The first motor 215 and the second motor 220 may be longitudinally offset with respect to the vehicle 100. For example, the second motor 220 may be positioned in a vehicle-forward direction from the first motor 215.

The first motor 215 and the second motor 220 are arranged to move the sensor unit 110 from the retracted position to the extended position and from the extended position to the retracted position. For example, the motors 215, 220 may be drivably coupled to respective worm gears 250, 255 engaged with the sensor unit 110 (e.g., a first worm gear 250 drivably coupled to the first motor 215 and a second worm gear 255 drivably coupled to the second motor 220). In other words, rotational output from the motors 215, 220 drives the respective worm gears 250, 255. The worm gears 250, 255 may have a cylindrical shape with a spiral groove. The worm gears 250, 255 may be elongated vertically. The spiral grooves of the worm gears 250, 255 may be engaged with corresponding spiral grooves of the sensor unit 110 (e.g., of the base 210) such that rotation of the worm gears 250, 255 causes the sensor unit 110 to travel along the lengths of the worm gears 250, 255 (i.e., vertically up and down). The motors 215, 220 may be actuated together in one direction to move the sensor unit 110 up from the retracted position to the extended position, and the motors 215, 220 may be actuated together in the opposite direction to move the sensor unit 110 down from the extended position to the retracted position.

The first motor 215 and the second motor 220 may be arranged to, while the sensor unit 110 remains in the extended position, adjust a pitch of the sensor unit 110, as can be seen in a comparison of FIGS. 2B and 2C. The term “pitch” is used herein in its kinematic sense of a rotational degree of freedom about a horizontal lateral axis (i.e., tilting a front end downward or upward). The pitch of the sensor unit 110 may be measured with respect to the body 140 of the vehicle 100. The longitudinal offset of the first motor 215 and the second motor 220 enables the motors 215, 220 to adjust the pitch. For example, to adjust the pitch downward, the first motor 215 may actuate to raise a rear end of the sensor unit 110, the second motor 220 may actuate to lower a front end of the sensor unit 110, or both. To adjust the pitch upward, the first motor 215 may actuate to lower a rear end of the sensor unit 110, the second motor 220 may actuate to raise a front end of the sensor unit 110, or both. Adjusting the pitch downward moves the field of view of the environmental sensor 120 closer to the front end of the vehicle 100, and adjusting the pitch upward moves the field of view farther out from the front end of the vehicle 100.

The first seal 130 is attached to the cover 125 and extends around the cover 125. For example, the first seal 130 may be adhered to the cover 125. The first seal 130 may circumscribe the cover 125. The first seal 130 may extend outward from the cover 125. The first seal 130 may have a constant cross-section projected along a path following the perimeter of the cover 125. The cross-section may extend from a thicker end that is attached to the cover 125 to a thinner end that contacts the cutout 155 when the sensor unit 110 is in the retracted position. The size of the cross-section (e.g., the width of the first seal 130) may be chosen to have a horizontal overlap with the roof panel 115 around the cutout 155. A portion of the first seal 130 is positioned above the sensor lens 245 and in the vehicle-forward direction from the sensor lens 245, and the first seal 130 and the cover 125 may act as a shade for the sensor lens 245, in addition to sealing the roof panel 115.

The first seal 130 is watertight with the roof panel 115 when the sensor unit 110 is in the retracted position. The first seal 130 may be a material that is flexible so as to be pressed against the cutout 155 (e.g., rubber). The material may also be hydrophobic. The first seal 130 may extend along a full perimeter of the cutout 155 when the sensor unit 110 is in the retracted position, thereby blocking liquid from entering the chamber 205.

The second seal 135 is attached to the base 210 and extends around the base 210. For example, the second seal 135 may be adhered to the base 210. The second seal 135 may circumscribe the base 210. The second seal 135 may extend outward from the base 210. The second seal 135 may have a constant cross-section projected along a path following the perimeter of the base 210. The cross-section may extend from a thicker end that is attached to the base 210 to a thinner end that contacts the cutout 155 when the sensor unit 110 is in the extended position. The size of the cross-section (e.g., the width of the second seal 135) may be chosen to have a horizontal overlap with the roof panel 115 around the cutout 155.

The second seal 135 is watertight with the roof panel 115 when the sensor unit 110 is in the extended position. The second seal 135 may be a material that is flexible so as to be pressed against the cutout 155, even when the pitch of the sensor unit 110 is adjusted (e.g., rubber). The material may also be hydrophobic. The second seal 135 may extend along a full perimeter of the cutout 155 when the sensor unit 110 is in the extended position, thereby blocking liquid from entering the chamber 205.

The wiper blade 225 is fixed relative to the chamber 205 (i.e., is stationary with respect to the chamber 205). The wiper blade 225 is positioned to wipe the sensor lens 245 as the sensor unit 110 moves between the retracted position and the extended position. For example, the wiper blade 225 may be elongated laterally relative to the vehicle 100 across the cutout 155. The wiper blade 225 is directed toward the environmental sensor 120 (e.g., in a vehicle-rearward direction, that is, tapering to a narrow edge in the vehicle-rearward direction). The wiper blade 225 may be positioned such that the narrow edge of the wiper blade 225 contacts the top of the sensor lens 245 when the sensor unit 110 is in the retracted position and contacts a bottom of the sensor lens 245 when the sensor unit 110 is in the extended position. As the sensor unit 110 moves between the retracted position and the extended position, the wiper blade 225 slides between the top and bottom of the sensor lens 245, thereby cleaning the sensor lens 245.

With reference to FIG. 3, the sensor unit 110 may include at least one heater 305 positioned to heat the cover 125. The at least one heater 305 may be a plurality of heaters 305. The at least one heater 305 may extend along the perimeter of the cover 125, thereby being positioned to melt ice that might obstruct the sensor unit 110 from moving from the retracted position to the extended position. For multiple heaters 305, the heaters 305 may be positioned to heat respective zones of the cover 125. For example, the heaters 305 may include four heaters 305, one for each edge or quadrant of the cover 125. The use of multiple heaters 305 can remove ice in an energy-efficient manner by activating only one or a subset of the heaters 305.

The heaters 305 can generate heat by resistive heating, also called Joule heating. The heaters 305 are conductors, and the resistance of the heaters 305 to electrical current flowing through the heaters 305 generates the heat. The amount of heat generated by the heaters 305 can be adjusted by adjusting the electrical current flowing through the heaters 305. For example, the heaters 305 may be embedded in the cover 125, thereby simplifying the manufacturing and assembly process. For another example, the cover 125 may be formed of conductive plastic, and the conductive plastic may be the heater 305. The conductive plastic may be an intrinsically conductive polymer and may be chosen to have a sufficiently high resistance to generate heat for melting ice.

With reference to FIG. 4, the drainage system 400 may include a drain port 405, a drain tube 410, a filter 415, a reservoir 420, a pump 425, a supply line 430, and the nozzle 230. Alternatively, the nozzle 230 may be separate from the drainage system 400.

The chamber 205 may include the drain port 405. The drain port 405 is an opening extending through the chamber 205. The drain port 405 may be at a lowest point of the chamber 205 (e.g., through the bottom panel 235).

The drain tube 410 is positioned to receive fluid from the chamber 205 (e.g., by being attached at the drain port 405). The drain tube 410 extends downward from the chamber 205 (e.g., downward from the drain port 405). The drain tube 410 may be, for example, a flexible hose. The drain tube 410 is positioned to direct the fluid to the reservoir 420. For example, if the reservoir 420 is located in a front end of the vehicle 100, the drain tube 410 may extend along a column adjacent to the windshield 150 to the front end.

The filter 415 removes solid particulates such as dirt and debris from fluid flowing through the filter 415. The filter 415 may be any suitable type of filter (e.g., paper, foam, cotton, stainless steel, oil bath, etc.). The filter 415 is positioned to filter the fluid passing through the drain tube 410 before the fluid reaches the reservoir 420. For example, the filter 415 may be located in the drain tube 410 and extend completely across the drain tube 410.

The reservoir 420 may be a tank fillable with liquid (e.g., fluid from the drain tube 410). The reservoir 420 may be disposed in the front end of the vehicle 100, specifically, in an engine compartment forward of the passenger compartment 145. The reservoir 420 may store the fluid for supplying the nozzle 230 and/or for other purposes, such as supply to the windshield 150.

The pump 425 may force the fluid through the supply line 430 to the nozzle 230 with sufficient pressure that the fluid sprays from the nozzle 230. The pump 425 is fluidly connected to the reservoir 420. The pump 425 may be attached to or disposed in the reservoir 420.

The nozzle 230 may be positioned to receive fluid from the reservoir 420 that was collected via the drain tube 410 (e.g., via the pump 425 and the supply line 430). Alternatively, the nozzle 230 may receive fluid from a source in the vehicle 100 that is unconnected to the drainage system 400. The nozzle 230 is aimed at the sensor lens 245, at least when the sensor unit 110 is in the retracted position. The nozzle 230 may thus be used to clean the sensor lens 245 when the sensor unit 110 is not in use (i.e., is not collecting data).

As one example, the nozzle 230 may be movable with the sensor unit 110 between the retracted position and the extended position, as shown in FIG. 2A-C. The nozzle 230 may be fixedly mounted on the base 210. The nozzle 230 may thus move together with the sensor unit 110 between the retracted position and the extended position. The nozzle 230 can be used to clean the sensor lens 245 regardless of whether the sensor unit 110 is in the retracted position or the extended position.

As another example, the nozzle 230 may be fixed relative to the chamber 205, as shown in FIG. 4. For example, the nozzle 230 may be mounted on the chamber 205 (e.g., on the bottom panel 235). The nozzle 230 may remain in the chamber 205 when the sensor unit 110 moves to the extended position. The nozzle 230 may be used to clean the sensor lens 245 when the sensor unit 110 is in the retracted position. The chamber 205 may protect the nozzle 230 from the environment.

With reference to FIG. 5, the control system 500 may include a computer 505, a communications network 510, the first motor 215, the second motor 220, the heater 305, and the pump 425.

The computer 505 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 505 can thus include a processor, a memory, etc. The memory of the computer 505 can include media for storing instructions executable by the processor as well as for electronically storing data and/or databases and/or the computer 505 can include structures such as the foregoing by which programming is provided. The computer 505 can be multiple computers coupled together.

The computer 505 may transmit and receive data through the communications network 510. The communications network 510 may be a controller area network (CAN) bus, Ethernet, WiFi, Local Interconnect Network (LIN), onboard diagnostics connector (OBD-II), and/or any other wired or wireless communications network. The computer 505 may be communicatively coupled to the first motor 215, the second motor 220, the heater 305, the pump 425, and other components via the communications network 510.

The computer 505 may be programmed to actuate the motors 215, 220 to move the sensor unit 110 from the retracted position to the extended position and from the extended position to the retracted position. For example, the computer 505 may actuate the motors 215, 220 to actuate for a preset length of time or preset number of revolutions. The preset value may be chosen based on a speed of the motors 215, 220 to move the sensor unit 110 between the retracted position and the extended position.

The computer 505 may be programmed to determine a pitch of the vehicle 100. The pitch of the vehicle 100 may be a pitch of the body 140 of the vehicle 100 measured with respect to the ground on which the vehicle 100 is sitting. For example, the computer 505 may determine the pitch of the vehicle 100 based on data from, for example, suspension sensors reporting the extensions of shocks of the vehicle 100. The computer 505 may store a formula giving the pitch of the vehicle 100 as a function of the extensions of the shocks, as is known. For example, comparatively greater extensions on the front shocks than the rear shocks indicates that the vehicle 100 is tilted upward, which may occur when a load is placed in the rear of the vehicle 100.

The computer 505 may be programmed to actuate at least one of the first motor 215 or the second motor 220 to adjust the pitch of the sensor unit 110 based on the data indicating the pitch of the vehicle 100. For example, the computer 505 may store a formula giving the time or number of revolutions to actuate the first motor 215 and/or the second motor 220 as a function of the pitch of the vehicle 100, or the computer 505 may store a table pairing values for the time or number of revolutions to actuate the first motor 215 and/or the second motor 220 with values for the pitch of the vehicle 100. The formula or table may be chosen to compensate for the pitch of the vehicle 100 by adjusting the pitch of the sensor unit 110 such that the field of view covers the same area in front of the vehicle 100 even as the pitch of the vehicle 100 changes. Thus, the pitch of the vehicle 100 and the pitch of the sensor unit 110 are inversely related by the formula or table; in other words, as the vehicle 100 tilts back, the sensor unit 110 tilts forward, and vice versa. Upon receiving the data indicating the pitch of the vehicle 100, the computer 505 may consult the formula or table and actuate the first motor 215 and/or the second motor 220 according to the formula or table.

The computer 505 may be programmed to actuate the heater 305 or heaters 305. For example, the computer 505 may actuate the heater 305 in response to a temperature being below a threshold. For example, the computer 505 may receive an ambient temperature from an outside air temperature sensor (OATS), or the computer 505 may receive multiple temperatures from thermocouples on the cover 125 corresponding to the zones of the cover 125. The threshold may be chosen to indicate a possibility of freezing.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Terms such as “front,” “forward,” “longitudinal,” “back,” “rearward,” “left,” “right,” “lateral,” “upward,” “downward,” “vertical,” etc., are understood relative to the vehicle 100. Use of “in response to,” “upon determining,” “upon receiving,” etc. indicates a causal relationship, not merely a temporal relationship. Many modifications and variations of the present disclosure are possible in light of the above teachings, and the disclosure may be practiced otherwise than as specifically described.

What is claimed is:

1. A sensor assembly comprising:
a chamber extending downward from a roof panel of a vehicle; and
a sensor unit mounted to the chamber;
the sensor unit being vertically movable between a retracted position in the chamber and an extended position extending above the roof panel;
the sensor unit including:
a base;
an environmental sensor fixedly mounted to the base;
a cover positioned above the environmental sensor and fixed relative to the base;
a first seal extending around the cover; and
a second seal extending around the base;
the first seal being watertight with the roof panel when the sensor unit is in the retracted position; and
the second seal being watertight with the roof panel when the sensor unit is in the extended position.

2. The sensor assembly of claim 1, wherein:
the roof panel includes a cutout through which the sensor unit in the extended position extends;
the first seal extends along a full perimeter of the cutout when the sensor unit is in the retracted position; and
the second seal extends along the full perimeter of the cutout when the sensor unit is in the extended position.

3. The sensor assembly of claim 1, wherein the cover is flush with the roof panel when the sensor unit is in the retracted position.

4. The sensor assembly of claim 1, wherein:
the sensor unit includes a sensor lens, a field of view of the environmental sensor projecting through the sensor lens in a vehicle-forward direction; and
a portion of the first seal is positioned above the sensor lens and in the vehicle-forward direction from the sensor lens.

5. The sensor assembly of claim 1, further comprising a motor arranged to move the sensor unit from the retracted position to the extended position and from the extended position to the retracted position.

6. The sensor assembly of claim 5:
wherein the motor is a first motor;
the sensor assembly further comprising a second motor arranged to move the sensor unit from the retracted position to the extended position and from the extended position to the retracted position, the second motor positioned in a vehicle-forward direction from the first motor.

7. The sensor assembly of claim 6, wherein the first motor and the second motor are arranged to, while the sensor unit remains in the extended position, adjust a pitch of the sensor unit.

8. The sensor assembly of claim 7:
further comprising a computer communicatively coupled to the first motor and the second motor;
wherein the computer is programmed to actuate at least one of the first motor or the second motor to adjust the pitch of the sensor unit based on data indicating a pitch of the vehicle.

9. The sensor assembly of claim 1:
further comprising a wiper blade fixed relative to the chamber;
wherein the sensor unit includes a sensor lens, a field of view of the environmental sensor projecting through the sensor lens; and
the wiper blade is positioned to wipe the sensor lens as the sensor unit moves between the retracted position and the extended position.

10. The sensor assembly of claim 1, wherein the sensor unit further includes a heater positioned to heat the cover.

11. The sensor assembly of claim 10, wherein the cover is formed of conductive plastic, the conductive plastic being the heater.

12. The sensor assembly of claim 10, wherein the sensor unit includes a plurality of heaters including the heater, the heaters positioned to heat respective zones of the cover.

13. The sensor assembly of claim 1:
further comprising a nozzle;
wherein the sensor unit includes a sensor lens, a field of view of the environmental sensor projecting through the sensor lens; and
the nozzle is aimed at the sensor lens when the sensor unit is in the retracted position.

14. The sensor assembly of claim 13, wherein the nozzle is movable with the sensor unit between the retracted position and the extended position.

15. The sensor assembly of claim 13, wherein the nozzle is fixed relative to the chamber.

16. The sensor assembly of claim 1, further comprising a drain tube positioned to receive fluid from the chamber and extending downward from the chamber.

17. The sensor assembly of claim 16, wherein the drain tube is positioned to direct the fluid to a reservoir of the vehicle.

18. The sensor assembly of claim 17, further comprising a filter positioned to filter the fluid passing through the drain tube before the fluid reaches the reservoir.

19. A sensor assembly comprising:
a chamber extending downward from a roof panel of a vehicle;
a sensor unit mounted to the chamber;
a first motor; and
a second motor positioned in a vehicle-forward direction from the first motor;
the sensor unit being vertically movable between a retracted position in the chamber and an extended position extending above the roof panel;
the first motor and the second motor being arranged to move the sensor unit from the retracted position to the extended position and from the extended position to the retracted position; and
the first motor and the second motor are arranged to, while the sensor unit remains in the extended position, adjust a pitch of the sensor unit.
